(19) United States
(12) Patent Application Publication
(10) Pub. No.: US 2010/0102052 A1
(43) Pub. Date: Apr. 29, 2010

(54) SELF-REGULATING ELECTRICAL RESISTANCE HEATING ELEMENT

(75) Inventor: Jeffery Boardman, Warrington Chesire (GB)

Correspondence Address: RADER, FISHMAN & GRAUER PLLC, 39533 WOODWARD AVENUE, SUITE 140, BLOOMFIELD HILLS, MI, 48304-0610, US

(73) Assignee: 2D HEAT LIMITED, Liverpool (GB)

(21) Appl. No.: 12/522,102

(22) PCT Filed: Dec. 21, 2007
(86) PCT No.: PCT/GB2007/004999

§ 371 Date: Dec. 7, 2009

(30) Foreign Application Priority Data
Jan. 4, 2007 (GB) 0700079.7

(51) Int. Cl. H05B 3/02; H01C 7/04

(52) U.S. Cl. 219/539; 219/490; 29/610.1

(57) ABSTRACT

The present invention relates to a self-regulating electrical resistance heating element, to an appliance containing same, and to processes for their manufacture. The self regulating electrical resistance heating element (10) comprises a substrate (12) comprising an electrically conductive coating (12a) which serves as a first electrical contact (18) on one side of the composite metal oxide layers. Disposed on said electrically conductive layer (12a) is a first metal oxide (14) which has a positive temperature coefficient of resistance. Overlaying the first metal oxide layer, and in electrical series thereto, is a second metal oxide layer (16) having a negative temperature coefficient of resistance and overlaying this layer is a second electrical contact (20). The second metal oxide layer (16) having a negative temperature coefficient of resistance is applied to the element in a manner which ensures it's resistive characteristics are not altered.

### TECHNICAL FIELD

The present invention relates to a self-regulating electrical resistance heating element, to an appliance containing same, and to processes for their manufacture.

### BACKGROUND OF THE INVENTION

Conventional electrical heating elements of the tubular sheathed variety or screen printed type do not have self-regulating properties and when connected to an electrical power source will continue to heat up until they fail by burning out and self-destructing.

The safe use of these conventional elements in appliances is achieved by combining them in series with some form of temperature sensitive control device, which effectively cuts off the electrical supply when a predetermined temperature level has been reached.

Generally these temperature sensitive control devices incorporate bimetals in various configurations and rely on the ability of the bimetallic components to deflect at or around a predetermined temperature to provide a mechanical action which “breaks” the electrical supply contacts, thus interrupting the electrical power supply to the elements concerned.

Whilst such temperature sensitive bimetallic and other similar control devices are widely used, and are produced to high quality standards, they are generally mechanical and like all mechanical mass produced devices are subject to the probability of failure, which increases with usage.

The operational failure of such temperature sensitive control devices will result in the over-heating and self-destruction of the associated elements, with potentially catastrophic results for the user.

Electrical heating elements are available which have self-controlling characteristics. These are manufactured from various compositions of, usually, barium titanate doped with small quantities of other metals. Their resistance increases by several powers of ten when the temperature is raised to the vicinity of the Curie Point, also known as the “switching” temperature. However, such heating elements have a number of limitations which severely limit their widespread application and usage. Some of these are set out below:
The major disadvantage of doped barium titanates is the inherent property that the resistivity of such materials is not constant over the temperature range from ambient to the “switching” temperature or Curie Point, but rather resistivity reduces progressively with increasing temperature before increasing to a high value.
A further disadvantage is that the rate and magnitude of reduction of resistance in such materials varies appreciably according to the composition and concentration(s) of the dopant or combination of dopants used.

As a consequence of the above, heating elements manufactured from such compositions exhibit operational resistances which reduce significantly from that measured at ambient temperature, to that just prior to the “switching” temperature or Curie Point, a reduction which can be as high as half of the original resistance. Furthermore this reduction occurs in an unpredictable manner.

The above failings presents the domestic appliance manufacturers and others utilising such elements with the problem of deciding which ambient resistance to produce such elements to, in order to maximise the power output.

In explanation of this, consider the use of a conventional element in a domestic water heating device operating with a single phase 230 volt AC supply. The maximum current allowed for 230 volt appliances is 13 amps and by Ohm's Law this defines the maximum power output of such single element appliances to circa 3 kilowatts, and consequently the minimum resistance of the heating element employed to 17.7 ohms.

In general, the resistance of such conventional elements does increase slightly with increases in operating temperature, but only by some 1-2%. Consequently the generation of heat by the element, and transfer of this energy to the water, is at a maximum when the temperature is at a minimum and is only slightly reduced from this as the boiling point is reached.

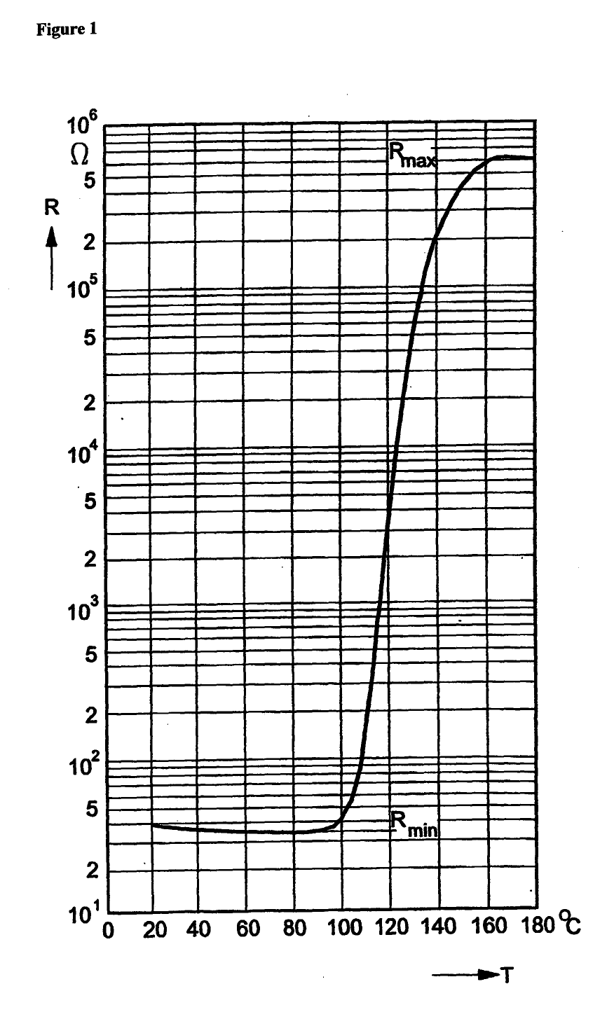

The same power and current limitations apply to doped barium titanate elements such that the minimum resistance of 17.7 ohms would need to be at a temperature near the “switching” or Curie Point, resulting in a higher resistance at ambient temperature. Assuming a resistance decrease over the appropriate temperature range of, say, 25%, a typical doped barium titanate element would need to be produced with an ambient resistance of 23.6 ohms. Using Ohm's Law it can be shown that at the start of the water heating cycle the thermal energy available is only 2.24 kw, rising to 3 kw only when the boiling point is reached. This is the opposite effect of that required by the domestic appliance manufacturers and an example of the resistance-temperature characteristic of a doped barium titanate composition with the Curie Point “switching” temperature at 120° C. is shown in FIG. 1.

A yet further disadvantage with doped barium titanate elements arises from the method used to produce them. Doped barium titanates derive their particular temperature/resistance properties mainly from the characteristics of the grain boundaries between the individual particles making up the bulk matrix of any particular piece. Thus, objects made of doped barium titanates are produced by pressing together, to the appropriate size and shape depending on the required finished object, the required amount of fine powder particles of the appropriate composition in a press, usually with a binding agent and then sintering the pressed mass in a furnace at the requisite temperature to produce a homogeneous product. Whilst this is an adequate manufacturing process it may result in products which are not fully dense from the pressing stage, and therefore do not exhibit uniform operating characteristics or have residual stresses from the sintering stage. As a consequence they are prone to cracking and operational failure during subsequent thermal cycles. Accordingly it is necessary to pre-test the elements with failing elements being discarded.

The inventor has previously proposed using two different metal oxides to produce a self regulating heating element. Published applications include GB2344042, GB237383 and GB 2374784. The most pertinent is GB2374783 which proposes using successive layers of different metal oxides deposited on an electrically conductive metal substrate, the layers of metal oxides having both different compositions and degrees of oxidation. Indeed, it proposes the use of nickel-chrome type metal oxides in combination with barium titanates. Significantly, both this and the other applications teach methodology in which both metal oxide layers are deposited using thermal spraying techniques. The inventor has found that the methodology employed and disclosed in the earlier applications did not result in elements having the desired characteristics because the thermal spraying of the doped barium titinates resulted in the destruction of the dopants (probably due to vaporisation).

The present invention seeks to overcome, or very substantially reduce, the problems described above and produce elements with the desired characteristics.

### PRESENT INVENTION

According to a first aspect of the present invention there is provided a self regulating electrical resistance heating element comprising:
a substrate which is, or comprises, an electrically conductive surface and which comprises a first electrical contact;
a first metal oxide having a positive or negative temperature coefficient of resistance;
a second metal oxide having a temperature coefficient of resistance opposite to that of said first metal oxide;
one of said first or second metal oxide's being disposed on the electrically conductive surface and the other of the first or second metal oxide's being disposed electrically in series above said first or second metal oxide,
a second electrical contact being disposed on the metal oxide which is not disposed on said electrically conductive surface such that a current can pass between the contacts through the metal oxides
   characterised in that said metal oxide having a negative temperature coefficient of resistance comprises a dopant which is present in an amount such that in combination the first and second metal oxides provide a substantially constant combined resistance from an ambient to a predetermined operating temperature and a very substantial increase in resistance above the operating temperature.

By providing an electrical heating element which has the required self-controlling characteristic in that the resistivity and resistance of the said element are nearly constant over the temperature range from ambient to the required operation limit, but which once the operating temperature marginally exceeds that predetermined operating limit the resistance increases by a power of ten or more, a safer and more efficient element results.

Furthermore, the methodology for their production ensures greater consistency is achieved during production of such elements.

Preferably, the first and second metal oxides are selected to provide a constant combined resistance from an ambient to a predetermined operating temperature and a very substantial increase in resistance above the operating temperature.

In a favoured embodiment the first metal oxide is an oxide of at least nickel and chromium and most preferably at least nickel, chromium and iron and the second metal oxide is a ferro-electric material.

Preferably, the ferro-electric material is a crystalline structure of the perovskite type and is of the general formula ABO₃ where A is a mono-, di- or tri-valent cation, B is a penta-, tetra- or tri-valent cation and O₃ is an oxygen anion.

Most preferably, the ferro-electric material is a doped barium titanate.

Typical dopants are those familiar to the man skilled in the art and include: lanthanum, strontium, lead, caesium, cerium and other elements from the lanthanide and actinide series.

Preferably the ferro-electric material comprises granular particles and said granular particles are more preferably deposited in a liquid or as a slurry, dispersion or paste. It is important that the ferro-electric material is deposited in a manner which does not result in its resistive properties, which are characterised by, amongst other things, the dopants used being altered. In this respect thermal processes which can vapourise the dopant or otherwise destroy the material are not used since the resulting product will not have the desired characteristics.

Preferably the particles are fine particles with a size range of from 20-100 microns and are deposited in a layer having a thickness of typically, from 100 to 500 microns.

Such mixed ferro-electric metal oxides are also generally known as oxygen-octahedral-ferro-electrics, and the characteristics of these materials, which include initial resistivity, variation of resistivity with temperatures and Curie Point or “switching” temperature, may be varied by variations in composition.

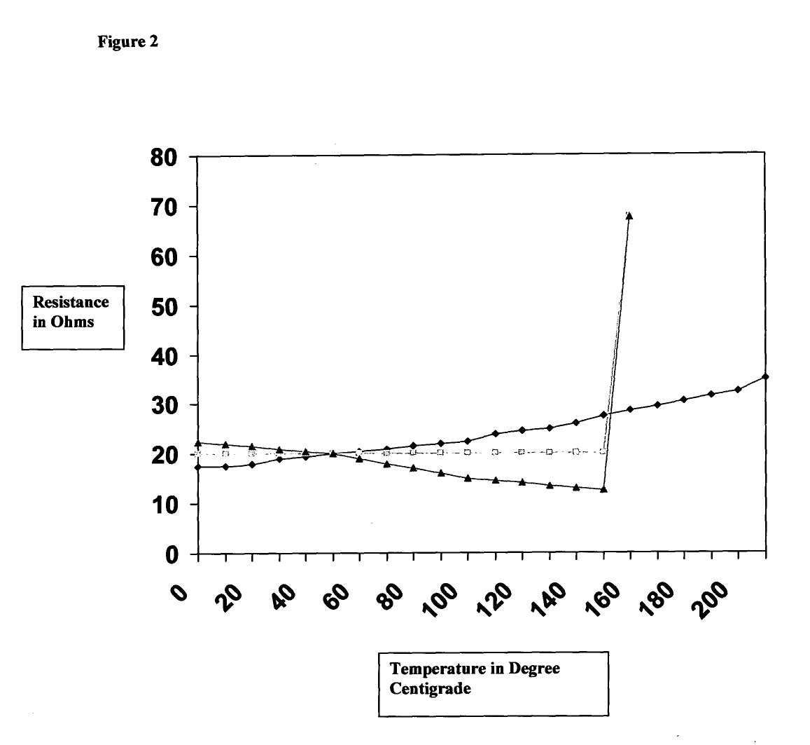

All the oxygen-octahedral-ferro-electric metal oxides exhibit the characteristic of reducing resistivity (negative temperature coefficient of resistance) with increasing temperature up to the Curie Point or “switching” temperature and this is compensated for in the elements of the invention by placing one or more different metal oxides (with a positive temperature coefficient of resistance) in series such that the resistivity is “balanced”. This is most clearly illustrated in FIG. 2.

The process for deriving this balanced compensation in reduction in resistance is not straightforward, involving a combination of calculation and empirically observed behaviours. Factors involved in the consideration include:
the end-value of the Curie Point required,
the nature of the oxygen-octahedral-ferro-electric metal oxide to be used,
the nature and concentration of the dopant or dopants to be used,
the resultant rate of decrease in the resistivity and resistance to the Curie Point,
the nature and composition of the thermally sprayed resistive metal oxide or metal oxide combinations which it is necessary to apply in order to compensate both the initial resistance level at ambient temperature and the rate of increase of the same to the required Curie Point, and
the physical thickness (and consequent economic cost) of the two consecutive element layers as well as the resultant temperature differential operating across the combination.

In essence, the selection of suitable combinations for a given purpose involves a degree of trial and error, taking into account the above.

Achievement of the required initial level of resistance for the thermally sprayed resistive metal oxide or metal oxide combinations (Nickel/Iron/Chromium) may optionally include adjustment using an intermittently pulsed high voltage electric current, either AC or DC, and which is the subject of UK patent application GB2419505 (PCT/GB2005/003949).

Thus, the increase in resistance with temperature of the Nickel/Iron/Chromium type metal oxide layer, essentially offsets the decrease in resistance with temperature of the doped barium titanate layer such that the combined resistance of the two resistive layers in series remains substantially constant from ambient to a predetermined operating temperature, but at the pre-determined operating temperature, the Curie Point or “switching” temperature of the doped barium titanate layer, the resistance of this layer increases by several powers of ten effectively increasing the overall combined element resistance to a high level, thus reducing the thermal power output to a very low level and acting as a self-regulating mechanism to prevent the element over-heating at temperatures above the predetermined operating level.

Given the above it is essential that in depositing the respective layers that their characteristic resistivity is not altered such that they will not function as originally intended.

The resistive properties of the doped barium titanates derive mainly from the grain boundary effects at the junctions between successive particles; The smaller the particle size range, the greater the number in any given volume of the barium titanate layer, and the greater the resistivity of the layer. The process of depositing doped barium titinates using a thermal process, such as flame spraying, changes the resistive properties, probably as a result of the vapourisation or destruction of the dopants. It also destroys the Curie point/switching effect.

In a favoured embodiment the first and second metal oxides are in intimate contact. Alternatively an electrically conductive layer can be deposited there between.

The electrically conductive substrate or surface may be any electrically conductive metal or metal alloy including, for example, aluminium, copper, mild or stainless steel. Alternatively an electrically insulating material, such as, for example, plastics, ceramics, glass or composites may be used as a substrate and an electrically conductive layer applied thereto. This layer can serve as an electrical contact on one side of the metal oxides composite, a second contact being provided on the other side of the metal oxides composite.

According to a second aspect of the present invention there is provided an electrical appliance comprising a heating element of the invention.

According to a third aspect of the present invention there is provided a method of adjusting the resistance of a resistive metal oxide layer comprising subjecting the layer to intermittent pulsing with a high voltage current. The current may be an AC or DC current.

According to a fourth aspect of the present invention there is provided a process for the manufacture of a self regulating resistance heating element comprising:
Applying to a substrate, which is or comprises an electrically conductive surface acting as a first electrical contact, a first metal oxide having a positive or negative temperature coefficient of resistance;
Applying above said first metal oxide, and electrically in series thereto, a second metal oxide having a temperature coefficient of resistance opposite to that of said first metal oxide;
Applying a second electrical contact over said second metal oxide such that a current can pass between the contacts through the metal oxides
   characterised in that said metal oxide having a negative temperature coefficient of resistance is deposited in a manner, and at a temperature below which any dopant present is not destroyed, such that in combination the first and second metal oxides provide a substantially constant combined resistance from an ambient to a predetermined operating temperature and a very substantial increase in resistance above the operating temperature.

The various aspects of the invention will be described further, by way of example, with reference to the following FIGS. in which:

FIG. 1 is a graph showing the resistance temperature characteristics of a barium titinate composition with a Curie point “switching” temperature at 120° C.;

FIG. 2 is a similar graph with the data for a Ni/Cr/Fe metal oxide superimposed against the data for a doped barium titanate to illustrate the “smoothing out” of the resistances; and

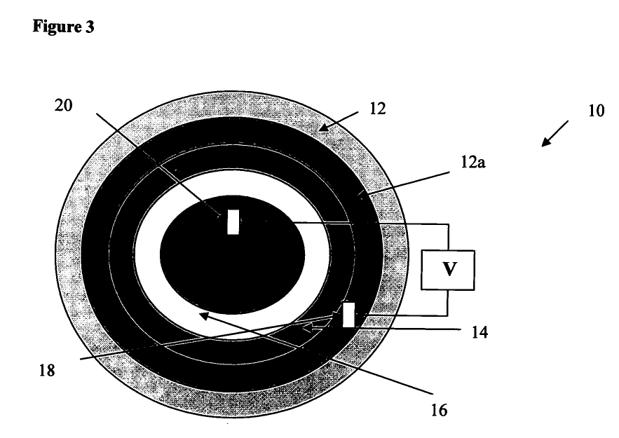

FIG. 3 is a plan of a heating element of the invention

### DETAILED DESCRIPTION

FIG. 1 illustrates the resistance temperature characteristics of a barium titinate composition with a Curie point “switching” temperature at 120° C. It will be noted that the between 20° C. and 100° C. the metal oxide has a negative temperature coefficient of resistance and that between 100° C. and 140° C. the resistance increases very significantly.

In FIG. 2, the resistance/temperature data for a metal oxide of the nickel, chromium and iron type which has a positive coefficient of resistance is shown together with that of a doped barium oxide with a Curie point of 160° C. Before reaching the Curie point the negative and positive resistances effectively cancel one another out (intermediate line) to provide a substantially constant resistance that then increases significantly at the Curie point. This increase in resistance is a consequence of the tetragonal crystalline form changing to a cubic form, locking up electrons and eliminating conduction.

### Example 1

### Construction

Referring to FIG. 3 the self regulating electrical resistance heating element (10) comprises a substrate (12) comprising an electrically conductive coating (12a) which serves as a first electrical contact (18) on one side of the composite metal oxide layers. Disposed on said electrically conductive layer (12a) is a first metal oxide (14) which has a positive temperature coefficient of resistance. Overlaying the first metal oxide layer, and in electrical series thereto, is a second metal oxide layer (16) having a negative temperature coefficient of resistance and overlaying this layer is a second electrical contact (20).

The first and second metal oxide layers are in intimate contact with each other, but in an alternative example an electrically contacting layer (not shown) can be provided there between.

A current can be passed between the first and second electrical contacts, through the respective metal oxide layers.

In the embodiment illustrated the supporting substrate (12) is a circular ceramic tile onto which has been deposited a copper layer (12a), although any electrically conductive metal or metal alloy could be used. A thermally sprayed resistive metal oxide layer of a Nickel/Iron/Chromium (14) is shown deposited over an appropriate area of the electrically conductive layer (12a) and a first electrical contact (18) is shown on the copper layer (12a).

Disposed over, and electrically in series with, the first metal oxide layer (14) is a layer of doped barium titanate (16) and overlying this is a second electrical contact (20).

It will be noted that the respective layers have been deposited such that a current passing between the first and second contact is forced through the resistive layers and can't pass directly from one contact to the other around, for example a perimeter.

The supporting substrate may have a wide variety of shapes and configurations ranging from a flat circular plate (as illustrated) to shapes including spheres, hemispheres, and hollow tubes of round or square cross-section, being either continuously straight or bent into helical or toroidal forms.

The shape of the supporting substrate will be determined by the requirement to optimise the transfer of the thermal energy developed by the electrical heating element to the media required to be heated by the particular appliance concerned.

The contact layer may be comprised of any electrically conductive material such as copper, nickel, aluminium, gold, silver, brass or conductive polymers, and may be applied by a broad variety of means, illustrated by (but not restricted to) flame spraying, chemical vapour deposition, magnetron sputtering techniques, electrolytic or chemical processes, to a solid piece being held in place with adhesives, mechanical pressure or magnetic means.

The relative configurations and relative sizes of said contact layer and metal oxide deposits is such as to prevent an electric current passing directly from the contact area to the conductive substrate or conductive layer on an insulating substrate when a voltage is applied between contacts and substrates.

For the conductive contact layer the thickness should be such that it will carry the maximum current required and allow it to distribute evenly over the whole of its surface such that the current passing through the metal oxides is uniform in density for each unit area of the metal oxides. This provision ensures that the heat energy generated within the volume of the resistive metal oxides is uniformly distributed, producing a uniform temperature over the appropriate area of the supporting substrate without any localised hot spots.

It is preferable, but not necessary, to make that area of the contact layer to which the external power supply point is to be fixed thicker than the remaining areas to assist in the even distribution of the current.

The supporting substrate may be comprised of any electrically conductive metal or metal alloy or an electrically insulating material and should be of a sufficient thickness to provide dimensional stability for the element during production and subsequent operational use.

### Example 2

### Methodology

The heating elements may be manufactured by, for example, thermally spraying a resistive metal oxide (14) with a positive temperature coefficient of resistance onto an electrically conductive surface (12a) of a substrate (12). Indeed, successive layers of the metal oxide may be applied by making a plurality of passes (anywhere from 1 to 10, more preferably 2 to 5, depending on the desired thickness—typically up to 500 μm) using thermal spray equipment. Since the electrical resistance of the resistive metal oxide deposit is dependent upon the thickness, it is possible to increase the resistance by increasing the thickness of the layer deposited. It is therefore preferred to deposit several layers.

It is known that metal alloys comprised of the nickel-chrome type when oxidised and thermally sprayed exhibit the desired characteristic of increasing resistivity/resistance with increased temperature. Such metal alloys are described in, for example, EP302589, U.S. Pat. No. 5,039,840 and PCT/GB96/01351. Such nickel-chrome type metal alloys may be oxidised to the required degree, as a precursor operation, prior to being thermally sprayed as one or more layers of the resistive metal oxide deposit, as described in GB2344042, or may be oxidised to the required degree during the thermal spraying operation. Indeed, the levels of, and rates of increase, in the resistivity and resistance of this metal oxide alloy layer with increasing temperature are significant factors in compensating for the asymmetric decreases in resistivity and resistance of the ABO₃ resistive oxide layer.

The other applied resistive oxide layer is preferably a doped barium titanate layer. It should not be deposited at high temperatures or it's resistivity is compromised. In a preferred embodiment it is applied in the form of a liquid or a paste, dispersion or slurry, comprising fine particles of barium titanate together with a dopant or dopants selected to match the predetermined operational switching temperature for a particular element design.

The paste, dispersion or slurry may be produced by the grinding of doped barium titanate pellets which have been produced to the required composition with appropriate Curie point characteristics and incorporating them into, for example, a suitable liquid adhesive.

The paste, dispersion or slurry (16) may then be applied over the upper surface of the first resistive metal oxide layer (14) by any of a broad range of suitable means, including, but not being limited to, by screen printing, painting, K-bar coating, spraying or the application of a quantity with subsequent smoothing out.

The liquid adhesive may be of any suitable composition such that it has the characteristics of binding the pre-mentioned fine doped barium titanate particles in close proximity to one another, to achieve the required grain boundary contact, and intimacy with the other metal oxide and a second electrical contact.

Indeed, the adhesive may be one which cures or sets at ambient or elevated temperatures (but not so high as to alter the resistive characteristics of the metal oxide) or by being exposed to air, light curing or a chemically initiated curing process.

Again, the electrical resistance of the doped barium titanate layer may be controlled by altering the particle size range and the thickness of the applied paste, dispersion or slurry.

Alternatively, it may be possible to deposit a layer using magnetron sputtering under controlled temperatures and vacuum.

A second electrical contact (20) may be applied to the upper surface of the doped barium titanate layer, such that on the application of a voltage supply (V) between this second electrical contact (20) and an electrical contact (18) on the conductive layer (12a) an electrical current (I) may be passed from the second electrical contact (20) through the thickness of the two resistive layers (14;16).

This second contact layer may be comprised of any electrically conductive material such as copper, nickel, aluminium, gold, silver, brass or conductive polymers and may be applied by any suitable means, exemplified by, but not restricted to, flame spraying, chemical vapour deposition, magnetron sputtering techniques, electrolytic or chemical processes, and applying a solid piece with adhesives, mechanical pressure or magnetic means.

The second contact layer is preferably smaller in area than the metal oxide layer on which it is deposited so as to ensure the electric current passes directly from the contact area to the conductive substrate or conductive layer on an insulating substrate when a voltage is applied between the contacts.

The contact layer should have a thickness such that it will carry the maximum current required and allow it to distribute evenly over the whole of its surface so that the current passing through the metal oxides is uniform in density for each unit area of the metal oxide. This provision ensures that the heat energy generated within the volume of the combined element is uniformly distributed, producing a uniform temperature over the appropriate area of the supporting substrate without any localised hot spots.

It will be apparent to the skilled man that the different metal oxides can be deposited in any order.

### Example 3

### Alternative Methodology

The metal oxides comprising the different layers of the self-regulating heating element may be applied to the supporting substrate in a variety of ways using different techniques.

A first methodology is to deposit a first metal oxide produced from e.g. Ni—Cr—Fe or similar alloys as one complete layer over the conductive surface of a substrate. It may be deposited by thermally spraying it over a given area and in a given configuration to the required calculated thickness. The second metal oxide, produced from e.g. doped barium titinate is then applied over the first metal oxide, again to the required calculated thickness and configuration the object being to “match” the two metal oxides to produce the required combined properties and characteristics of the heating element concerned.

Alternatively, the reverse of this first methodology may be utilised, whereby the oxygen-octahedral-ferro-electric oxide component is firstly applied to the supporting substrate followed by the second component metal oxide.

In other words, by selecting different metal oxides it is possible to determine, by the use of calculation and of empirically observed behaviours the dimensions and relationship between the various components comprising the type of electrical resistance heating element which is the subject of this present invention.

1. A self regulating electrical resistance heating element comprising:
a substrate, wherein the substrate is one of an electrically conductive surface and comprises of the electrically conductive surface, and which comprises a first electrical contact;
a first metal oxide having one of a positive and negative temperature coefficient of resistance;
a second metal oxide having a temperature coefficient of resistance opposite to that of said first metal oxide, wherein one of said first and second metal oxides being disposed on the electrically conductive surface and the other of the first or second metal oxides being disposed electrically in series above the selected one of said first and second metal oxide, and
a second electrical contact being disposed on one of the first and second metal oxide which is not disposed on said electrically conductive surface such that a current passes between contacts through one of the first and second metal oxide that includes the contacts;
at least one of said first and second metal oxide having the negative temperature coefficient of resistance comprises a dopant which is present in an amount such that in combination the first and second metal oxides provide a substantially constant combined resistance from an ambient to a predetermined operating temperature, and a substantial increase in resistance above the operating temperature; and
wherein one of said first and second metal oxide having the negative temperature coefficient of resistance comprises granular particles that are deposited in one of a liquid slurry, a dispersion and a paste.

2. The self regulating electrical resistance heating element as claimed in claim 1, wherein one of the first and second metal oxide having the positive temperature coefficient of resistance is an oxide of at least a nickel, iron and chromium.

3. The self regulating electrical resistance heating element as claimed in claim 1, wherein at least one of the first and second metal oxide having the negative temperature coefficient of resistance is a ferro-electric material.

4. The self regulating electrical resistance heating element as claimed in claim 3, wherein the ferro-electric material is a crystalline structure of the perovskite type and is of the general formula ABO₃ where A is one of a mono-, di- and tri-valent cation, B is one of a penta-, tetra- and tri-valent cation and O₃ is an oxygen anion.

5. The self regulating electrical resistance heating element as claimed in claim 4, which wherein the ferro-electric material is a doped barium titanate.

6. The self regulating electrical resistance heating element as claimed in claim 3, wherein the ferro-electric material comprises granular particles.

7. The self regulating electrical resistance heating element as claimed in claim 6, with a particle size of between about 20 and about 100 microns.

8. The self regulating electrical resistance heating element as claimed claim 3, wherein the ferro-electric material is present in a layer having a thickness of up to about 500 μm.

9. The self regulating electrical resistance heating element as claimed in claim 1, wherein the first and second metal oxides are in intimate contact.

10. The self regulating electrical resistance heating element as claimed in claim 1, wherein the first and second metal oxides are separated by an electrically conductive layer.

11. The self regulating electrical resistance heating element as claimed in claim 1, wherein the electrically conductive surface comprises of one of a metal and metal alloy.

12. The self regulating electrical resistance heating element as claimed in claim 1, wherein the self regulating electrical resistance heating element is included in an electrical appliance.

13. A method of adjusting the resistance of a resistive metal oxide layer, comprising:
subjecting the layer to intermittent pulsing with a high voltage current.

14. A process for the manufacture of a self regulating resistance heating element, comprising:
applying to a substrate wherein the substrate is one of an electrically conductive surface and comprises of the electrically conductive surface, wherein a first metal oxide has one of a positive and negative temperature coefficient of resistance;
applying above said first metal oxide, and electrically in series thereto, a second metal oxide having a temperature coefficient of resistance opposite to that of said first metal oxide; applying a second electrical contact over said second metal oxide such that a current passes between the contacts through the first and second metal oxides;
wherein at least one of said first and second metal oxide having the negative temperature coefficient of resistance comprises granular particles that are deposited such that at a temperature below which substantially any dopant present is not destroyed, as one of a liquid, a slurry, a dispersion or a paste, such that in combination the first and second metal oxides provide a substantially constant combined resistance from an ambient to a predetermined operating temperature and a substantial increase of at least a power of ten in resistance above the operating temperature.

15. The process as claimed in claim 14, wherein at least one of the first and second metal oxide having the positive temperature coefficient is applied as a plurality of layers.

16. The self regulating electrical resistance heating element as claimed in claim 2, wherein one of the first and second metal oxide having the negative temperature coefficient of resistance is a ferro-electric material.

17. The self regulating electrical resistance heating element as claimed in claim 16, wherein the ferro-electric material is a crystalline structure of the perovskite type and is of the general formula ABO₃ where A is one of a mono-, di- and tri-valent cation, B is one of a penta-, tetra- and tri-valent cation and O₃ is an oxygen anion.

18. The self regulating electrical resistance heating element as claimed in claim 17, wherein the ferro-electric material is a doped barium titanate.

19. The self regulating electrical resistance heating element as claimed in claim 4, wherein the ferro-electric material comprises granular particles.

20. The self regulating electrical resistance heating element as claimed in claim 19, with a particle size of between about 20 and about 100 microns.
